(19) United States
(12) Patent Application Publication
(10) Pub. No.: US 2026/0344696 A1
(43) Pub. Date: Nov. 5, 2026

(54) ROASTED COFFEE

(71) Applicant: SOCIÉTÉ DES PRODUITS NESTLÉ S.A., Vevey (CH)

(72) Inventors: Luigi POISSON, Courgevaux (CH); Sean Mackay MURPHY, Cossonay-Ville (CH); Tomas DAVIDEK, Chénens (CH); Elodie TCHAMENI, Lausanne (CH)

(21) Appl. No.: 19/124,729

(22) PCT Filed: Oct. 27, 2023
(86) PCT No.: PCT/EP2023/080031

§ 371 Date: Apr. 25, 2025

(30) Foreign Application Priority Data
Nov. 3, 2022 (EP) 22205211.0

(51) Int. Cl. A23F 5/06; A23F 5/04; A23F 5/16; A23F 5/26

(52) U.S. Cl. CPC A23F 5/06; A23F 5/046; A23F 5/166; A23F 5/26

(57) ABSTRACT

The present invention relates to a process for roasting coffee, in particular to roasting extracted green coffee at elevated pressure followed by roasting at lower pressures. Further aspects of the invention are a roast coffee and a container for use in a beverage preparation device, the container containing the roast coffee.

### FIELD OF THE INVENTION

The present invention relates to a process for roasting coffee, in particular to roasting extracted green coffee at elevated pressure followed by roasting at lower pressures. Further aspects of the invention are a roast coffee and a container for use in a beverage preparation device, the container containing the roast coffee.

### BACKGROUND OF THE INVENTION

The characteristic aroma and taste of coffee is developed during the roasting of the coffee beans. Lighter roasts are normally associated with higher perceived acidity and more fruity and winey aroma notes, whereas darker roasts develop more body and more roasty notes.

Coffee drinkers do not all share the same preferences in terms of coffee aroma and taste. Indeed, many coffee drinkers appreciate the variety of sensory experiences that coffee can provide, with different bean types, origins, blends and roasting processes all playing a role.

It is desirable when roasting coffee commercially to be able to modulate the taste and aroma of coffee. This can be to create new sensory characteristics or to maintain constant sensory characteristics for a coffee product over time, compensating for the changing seasonal availability of different coffee beans.

Hence, there is a persisting need in the industry to find improved solutions for roasting coffee.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

### SUMMARY OF THE INVENTION

An object of the present invention is to improve the state-of-the-art. The object of the present invention is achieved by the subject matter of the independent claims. The dependent claims further develop the idea of the present invention.

Accordingly, the present invention provides in a first aspect a process for roasting coffee comprising;
a. roasting extracted green coffee at a pressure greater than 2 bar for a period between 20 and 900 seconds, wherein the extracted green coffee before roasting comprises sucrose at an amount of less than 80% of the amount of sucrose in an un-extracted sample of the same coffee; and
b. roasting the roasted extracted coffee of step a at a pressure between 0.5 bar and 1.5 bar and at a coffee temperature of between 180 °C and 260 °C for a period between 20 and 1200 seconds.

In a second aspect, the invention provides a roast coffee having a weight ratio of dimethyl disulfide to 2,3-diethyl-5-methylpyrazine of greater than 4.

A third aspect of the invention relates to a container for use in a beverage preparation device, the container containing the roast coffee of the invention.

Surprisingly, it has been found by the inventors that roasting extracted coffee in two stages; the first roasting stage being at elevated pressure and the second roasting stage being at lower pressures such as atmospheric pressure, provides an enhanced capability to modulate the coffee into different taste regions, generating enhanced toasted cereal notes, increased fresh-roasted character and reduced earthy and medicinal notes such as those typically associated with robusta coffees. In particular, the resulting roasted coffee has high levels of aroma compounds associated with desirable toasted cereal, bread-like notes such as dimethyl disulfide, combined with low levels of aroma compounds associated with earthy notes such pyrazines that are characteristic of darkly-roasted robusta coffees. This effect occurs for both robusta and arabica coffee beans.

### DETAILED DESCRIPTION OF THE INVENTION

Consequently, the present invention relates in part to a process for roasting coffee comprising; a) roasting extracted green coffee (for example extracted green coffee beans) at a pressure greater than 2 bar for a period between 20 and 900 seconds, wherein the extracted green coffee before roasting comprises sucrose at an amount of less than 80% of the amount of sucrose in an un-extracted sample of the same coffee; and b) roasting the roasted extracted coffee of step a at a pressure between 0.5 bar and 1.5 bar and at a coffee temperature of between 180 °C and 260 °C for a period between 20 and 1200 seconds.

It has surprisingly been found by the inventors that roasting extracted green coffee according to steps a) and b) provides coffee with a pleasant sensory profile with enhanced toasted cereal notes. The resulting coffee may for example have a weight ratio of dimethyl disulfide to 2,3-diethyl-5-methylpyrazine of greater than 4. Furthermore, the resulting coffee shows a reduction in earthy and medicinal notes, these attributes usually being associated unfavourably with robusta coffee. The coffee shows an associated strong reduction in guaiacol, for example it may have a weight ratio of guaiacol to dimethyl disulfide of less than 30. It is surprising that the process of the invention is capable of generating desirable flavour profiles from extracted green coffee, which has had a large proportion of the water-soluble coffee flavour precursor molecules removed, such as monosaccharides, disaccharides, amino acids, chlorogenic acids and trigonelline. The green coffee extract may provide a valuable side-stream, for example as a source of caffeine (a cognitive enhancer, increasing alertness and attentional performance), chlorogenic acids (antioxidants) and trigonelline (a beneficial nutritional factor).

Roasting extracted green coffee at a pressure greater than 2 bar may for example be achieved by roasting extracted green coffee in a gas pressurized to a pressure greater than 2 bar.

Green coffee is the term used for unroasted coffee. Extracted green coffee is green coffee that has had some of its components extracted, for example by water extraction of green coffee beans. Sucrose is the most abundant sugar in green coffee, with about 8 wt. % in arabica coffee beans and about 3-6 wt. % in robusta coffee beans. The extracted green coffee according to the invention has been extracted such that it comprises sucrose at an amount of less than 80% of the amount of sucrose in an un-extracted sample of the same coffee. For example, a robusta coffee bean comprising 6 wt. % sucrose in its native state would comprise less than 4.8 wt. % sucrose as an extracted green coffee bean. In an embodiment, the extracted green coffee before roasting comprises sucrose at an amount of less than 60%, 40%, 30%, 20% or 15% of the amount of sucrose in an un-extracted sample of the same coffee. In an embodiment, the extracted green coffee comprises less than 3 wt. % sucrose. These values of weight percent sucrose are expressed as a percentage of the dry weight of the coffee.

In an embodiment, roasting extracted green coffee according to step a is performed in perforated rotatable drum in a pressurizable chamber.

In step b, the roasted extracted coffee is roasted at pressures around atmospheric pressure. For example the extracted coffee may be roasted at a pressure of between 0.8 and 1.2 bar, for example 0.9 to 1.1.

Roasting the roasted extracted coffee of step a according to step b may be performed in a suitable roasting device, for example a drum roaster, a fluidized bed roaster or a paddle roaster. The roasting according to step b may be performed in a separate device to that used for roasting extracted green coffee in step a. In an embodiment, the roasting according to step b is performed in a fluidized bed roaster or a paddle roaster. The roasting according to step b may be performed under an inert atmosphere such as nitrogen.

Many consumers expect the coffee they drink to contain no ingredients other than coffee beans. In an embodiment, the extracted green coffee is roasted in step a in the absence of any non-coffee ingredients such as added sugars. In an embodiment, the roasting of step b is performed in the absence of any non-coffee ingredients such as added sugars. In a further embodiment, all roasting steps in the process for roasting coffee are performed in the absence of non-coffee ingredients such as added sugars.

In an embodiment, the extracted green coffee is roasted in step a in the absence of any non-coffee bean ingredients such as other components of coffee cherries. In an embodiment, the roasting of step b is performed in the absence of any non-coffee bean ingredients such as other components of coffee cherries. In a further embodiment, all roasting steps in the process for roasting coffee are performed in the absence of any non-coffee bean ingredients such as other components of coffee cherries.

In an embodiment, the extracted green coffee is obtained by extracting green coffee (for example green coffee beans) with an aqueous liquid and then separating the extracted green coffee from the extract. The green coffee may be extracted for between 10 minutes and 6 hours, for example between 30 minutes and 3 hours, for further example between 50 minutes and 90 minutes. The extraction may be a counter-current extraction. The aqueous liquid may be water. The aqueous liquid may be at a temperature of between 20 and 100 °C during extraction, for example between 75 and 95 °C, for example between 60 and 90 °C. The weight ratio of water:coffee may be between 2:1 and 5:1, for example between 2.5:1 and 4.5:1. At least 20 wt. % of the soluble carbohydrates present in the unextracted green coffee may be extracted into the aqueous liquid, for example at least 30, 40, 50 or 60 wt. %. The soluble carbohydrates remaining in the green coffee after extraction may be less than 5 wt. % on a dry basis, for example less than 4, 3 or 2 wt. % on a dry basis. Separation of the extracted green coffee from the liquid may be achieved by any suitable means, e.g. filtration, centrifugation, and/or decanting. The extracted green coffee may be dried before further roasting, for example to a moisture content of between 8 and 15 wt. %, for example between 8 and 13 wt. %, for further example between 9 and 12 wt. %.

In the context of the present invention, green coffee is coffee (for example coffee beans) which has not been subjected to a temperature sufficiently high to initiate roasting. In an embodiment, the green coffee has not been heated to temperatures above 110 °C before extraction, for example the green coffee has not been heated to temperatures above 100, 90 or 80 °C before extraction. In a further embodiment, the green coffee has not been heated to temperatures above 110 °C during extraction, for example the green coffee has not been heated to temperatures above 100 or 90 °C during extraction.

In an embodiment, the roasted extracted coffee of step a is combined with aqueous green coffee extract before being roasted in step b. Green coffee extract is rich in water soluble compounds such as monosaccharides, disaccharides, amino acids, chlorogenic acids and trigonelline. These are all important precursors for flavour generation, especially monosaccharides, disaccharides and amino acids. Without wishing to be bound by theory, the inventors believe that roasting extracted green coffee at elevated pressure leads to a reduction in the levels of pyrazines (earthy notes) and guaiacol (phenolic, medicinal, smoky, ashy notes) providing a reduction in unwanted robusta character. However, the green coffee extract is protected from these relatively harsh conditions and then is re-incorporated for a second roasting step close to ambient pressure where the flavour precursors in the green coffee extract are allowed to react to form desirable flavours. The coffee may for example have a weight ratio of dimethyl trisulfide to 2,3-diethyl-5-methylpyrazine greater than 0.6.

In an embodiment, the aqueous green coffee extract is concentrated, e.g to a total solids of between 20 and 35%, before being combined with the roasted extracted coffee of step a and roasted according to step b.

The aqueous green coffee extract may have had most or all of the caffeine removed, for example such that when the roasted extracted coffee of step a is combined with the aqueous green coffee extract and roasted in step b. a de-caffeinated coffee results. Caffeine may be removed by the methods known in the art, such as contact with activated carbon pre-loaded with coffee extract substances so that caffeine is selectively removed. The aqueous green coffee extract may comprise less than 0.1 wt. % caffeine, for example less than 0.05 wt. % caffeine.

The roasted extracted coffee may be combined with aqueous green coffee extract in a mixer, for example a stirred jacketed mixer. The roasted extracted coffee may be held at a slight vacuum immediately before and/or during being combined with aqueous green coffee extract, for example at between 0.65 and 0.95 bar. This helps to maximize the incorporation of the aqueous green coffee extract into the roasted extracted coffee. Any aqueous green coffee extract that has not been taken up by the beans is removed, for example by sieving. In an embodiment the roasted extracted coffee may be combined with aqueous green coffee extract at a ratio of between 2:1 and 10:1 coffee to extract on a solids basis. This is the ratio of the roasted extracted coffee to the aqueous green coffee extract that has been taken up by the roasted extracted coffee. Preferably the quantity of aqueous green coffee extract is chosen such that it is completely absorbed by the roasted extracted coffee, however, in the event that there is surplus aqueous green coffee extract, it is removed by sieving or the like. Any surplus aqueous green coffee extract is not included for the purpose of calculating the ratio of roasted extracted coffee to aqueous green coffee extract. The roasted extracted coffee may be rinsed with fresh water after being combined with aqueous green coffee extract. The roasted extracted coffee may be dried after being combined with aqueous green coffee extract and before being roasted in step b, for example it may be dried to a moisture content of between 8 and 15 wt. %, for example between 8 and 13 wt. %, for further example between 9 and 12 wt. %.

In an embodiment, the aqueous green coffee extract is obtained by extracting green coffee (for example green coffee beans) with an aqueous liquid and then separating the extracted green coffee from the extract. The green coffee may be extracted for between 10 minutes and 6 hours, for example between 30 minutes and 3 hours, for further example between 50 minutes and 90 minutes. The extraction may be a counter-current extraction. The aqueous liquid may be water. The aqueous liquid may be at a temperature of between 20 and 100 °C during extraction, for example between 75 and 95 °C, for example between 60 and 90 °C. The weight ratio of water:coffee may be between 2:1 and 5:1, for example between 2.5:1 and 4.5:1. The aqueous green coffee extract may comprise sucrose, for example at a level between 15 and 45 wt. % on a dry basis, for further example between 20 and 40 wt. % on a dry weight basis. The aqueous green coffee may comprise amino acids, for example at a level between 0.8 and 4.0 wt. % on a dry basis, for further example between 1.0 and 3.8 wt. % on a dry weight basis. The aqueous green coffee extract may comprise free phenols, for example at a level between 15 and 40 wt. % on a dry basis, for further example between 20 and 35 wt. % on a dry weight basis. Examples of free phenols include caffeoylquinic acids, di-caffeoylquinic acids and feruloylquinic acids. The aqueous green coffee extract may comprise trigonelline, for example at a level between 1.5 and 4.0 wt. % on a dry basis, for further example between 2.0 and 3.5 wt. % on a dry weight basis. The aqueous green coffee extract may comprise caffeine, for example at a level between 3 and 15 wt. % on a dry basis, for further example between 4.5 and 10 wt. % on a dry weight basis. The aqueous green coffee extract may have been decaffeinated and may comprise less than 0.5 wt. % on a dry basis, for example less than 0.25 wt. % on a dry basis. In an embodiment, the aqueous green coffee extract on a dry basis comprises sucrose at a level between 15 and 45 wt. %, amino acids at a level between 0.8 and 4.0 wt. % and trigonelline at a level between 1.5 and 4.0 wt. %.

The aqueous green coffee extract may have a total solids level of between 10 and 50%, for example between 20 and 30%. Separation of the aqueous green coffee extract from the extracted green coffee may be achieved by any suitable means, e.g. filtration, centrifugation, and/or decanting.

In an embodiment, the extracted green coffee is roasted in the presence of superheated steam at a pressure greater than 9.5 bar in step a).

In an embodiment the superheated steam has a pressure greater than 10 bar, for example greater than 11 bar, for further example greater than 12 bar. The superheated steam may have a pressure from 9.5 bar to 20 bar, for example from 10 bar to 19 bar, for further example from 12 bar to 18 bar.

Pressures given in this document with the units “bar”, refer to absolute pressure, sometimes written bara or bar (a). 1 bar is equal to 100 kPa.

The temperature of the steam must be such that the steam is in a superheated state at the pressure of the steam, the steam supply being sufficient to maintain a superheated steam atmosphere. Pressure-enthalpy state diagrams for steam are widely available. Subject to being in a superheated state, the steam temperature may be from 180 °C to 330 °C, for example from 220 °C to 320 °C, for further example from 250 °C to 310 °C. For example, the superheated steam may be at a pressure of 13 bar and a temperature of 300 °C.

Roasting coffee in steam is not generally performed as the resulting coffee tends to be sour. However, the roasting conditions used in the process of the current invention surprisingly avoid this sourness, leaving a desirable fine acidity but without unpleasant sourness.

In an embodiment, the extracted green coffee in step a) may be roasted in the presence of superheated steam to a final temperature (for example a final bean temperature) of between 180 °C to 320 °C, for example from 190 °C to 300 °C, for further example from 200 °C to 280 °C.

In an embodiment, the moisture content of the coffee (for example coffee beans) after being roasted in the presence of superheated steam is lower than the moisture content of the unroasted beans. Superheated steam is “dry” in the sense that it does not contain water in the liquid phase. Simply steaming the coffee before roasting, for example with saturated steam, does not provide the desired modulation in taste, indeed high levels of coffee moisture (e.g. greater than or equal to 20 wt. % moisture in the bean) such as may be the result of steaming in wet steam drive unwanted sensory attributes such as undesired sourness and generation of sensorially undesirable compounds when the beans are subjected to roasting temperatures.

In an embodiment, the roast coffee has a titratable acidity of less than 20 mmol sodium hydroxide equivalents per 100 g roasted coffee, for example less than 15 mmol sodium hydroxide equivalents per 100 g roasted coffee, for further example less than 5 mmol sodium hydroxide equivalents per 100 g roasted coffee. Titratable acidity may for example be measured by suspending 10 g of roast and ground coffee with 200 mL of water and boiling it. After 5 min of boiling under agitation and cooling down, the evaporation losses are compensated by addition of water. The suspension is filtrated, and 50 ml of filtrate is titrated to pH 6.60 with a 0.1 M aqueous sodium hydroxide solution.

Surprisingly, the coffee resulting from roasting extracted coffee in the presence of superheated steam at a pressure greater than 9.5 bar in step a) and then combining with the aqueous green coffee extract before being roasted in step b) shows an increase in “coffeeness” character sensorially. Accordingly, the coffee may for example have a weight ratio of dimethyl disulfide to methanethiol greater than 1.5.

In an embodiment, in step b, the roasted extracted coffee is roasted in the absence of steam. By “roasted in the absence of steam” it is meant that no steam is introduced to the coffee during the roasting; some steam may inherently be generated from moisture in or on the coffee as it is heated.

In an embodiment, the process for roasting coffee comprises roasting extracted green coffee in the presence of superheated steam at a pressure greater than 12 bar for a period between 80 and 150 seconds wherein the extracted green coffee before roasting comprises sucrose at an amount of less than 80% of the amount of sucrose in an un-extracted sample of the same coffee; followed by roasting without steam at a pressure between 0.8 and 1.2 bar and a coffee temperature of between 180 °C and 220 °C for a period between 200 and 220 seconds.

Advantageously the process of the invention is able to generate tastes and aromas of a style normally associated with lightly roasted arabica coffee from robusta coffee. However, the coffee according to the invention may be arabica coffee (Coffea arabica), robusta coffee (Coffea canephora) or combinations of these. The coffee may be coffee beans (the seeds of the coffee plant) in the form of essentially whole beans, broken beans, ground beans or combinations of these.

In an embodiment, the extracted green coffee is roasted in the presence of an inert gas in step a). The pressure during roasting may be achieved by introducing the inert gas into the roaster under pressure. At least 98% of the gas atmosphere in which the beans are roasted may be an inert gas, e.g. the partial pressure of inert gas may be 98% of the total pressure. The inert gas may be nitrogen.

In an embodiment, the roasted coffee may be ground, for example the coffee may be ground after step b.

Beverage preparation devices (for example beverage preparation machines) which accommodate extractable portioned ingredients provide a convenient method of preparing beverages. Such portioned ingredients are generally packed in a container, configured for example as a pod, pad, sachet, pouch, capsule or the like. In an embodiment, the roasted coffee (for example roasted and ground coffee beans) are filled into a container, the container being for the preparation of a beverage when inserted into a beverage preparation device. The container may for example be a beverage capsule, among other configurations.

To best optimize the sensory characteristics of coffee, the roasting applied to a proportion of the beans in the final blend may be different from the roasting applied to other beans in the blend. For example, in a blend of beans from different origins and/or different types of the different origins/types of beans may be roasted separately under conditions to optimize the final flavour and aroma. In an embodiment, the beans after roasting in step b) are blended with further coffee beans that have been roasted under different conditions.

In an embodiment, the process for roasting coffee comprises; roasting a first type of extracted green coffee in the presence of superheated steam at a pressure greater than 9.5 bar for a period between 20 and 900 seconds, wherein the extracted green coffee before roasting comprises sucrose at an amount of less than 80% of the amount of sucrose in an un-extracted sample of the same coffee; and roasting the coffee roasted in the presence of superheated steam in a further roasting step without steam at a coffee temperature of between 180 °C and 260 °C and a pressure of between 0.8 and 1.2 bar for a period between 20 and 1200 seconds; and separately roasting a second type of green coffee; and blending the roasted first and second types of roasted coffee.

In an embodiment, the first type of extracted green coffee is from a different origin and/or a different coffee species than the second type of green coffee. The first type of extracted green coffee may be of a lower quality grade than the second type of coffee beans. The first type of extracted green coffee may for example be dry processed robusta or dry processed Brazilian Arabica beans. The second type of green coffee, being from a different origin and/or a different coffee species than the first type of coffee beans may be high quality beans with an intrinsic fruity/floral aroma and a fine acidity. By “different origin” is meant that the beans are grown in a different geographical region or country. Colombian, Kenyan, Costa Rican, Nicaraguan and Brazilian are examples of origins. The second type of green coffee may be selected from the group consisting of Colombian Arabica, Kenyan Arabica, Central American Arabica (for example Costa Rican or Nicaraguan), high quality Brazilian arabica, highest quality robusta and combinations of these.

The two stages of roasting of the process of the invention do not have to be performed in the same physical location. Roasters capable of roasting at elevated pressure or in the presence of superheated steam are generally more expensive than conventional roasters. It may make economic sense to have a central facility roasting extracted coffee at elevated pressure (optionally in the presence of superheated steam) and then ship this pressure-roasted exhausted coffee to a series of other sites, for example sites close to the sales location, to perform the roasting of step b. Where the roasted extracted coffee is to be combined with aqueous green coffee extract, this may also be performed at a central location. The roasting of step b may for example be performed at home or at a retail premises, widening the range of coffees with attractive aromas that can be offered. The coffee would typically be packed into containers for the transport. In an embodiment, the roasted extracted coffee of step a is packed into containers and transported to at least one other location before being roasted according to step b.

An aspect of the invention provides a process for roasting coffee comprising roasting extracted green coffee at a pressure greater than 2 bar for a period between 20 and 900 seconds, wherein the extracted green coffee before roasting comprises sucrose at an amount of less than 80% of the amount of sucrose in an un-extracted sample of the same coffee followed by packing into a container. For example, the extracted green coffee may be roasted to a colour having a CTN of greater than 100 followed by packing into a container.

A further aspect of the invention is the use of roasted extracted green coffee for subsequent roasting at home or at retail premises wherein the roasted extracted coffee has been subjected to roasting at a pressure greater than 2 bar for a period between 20 and 900 seconds, and wherein the extracted green coffee before roasting comprises sucrose at an amount of less than 80% of the amount of sucrose in an un-extracted sample of the same coffee.

The inventors were surprised to find that roast coffee according to the invention has improved sensory attributes confirmed by aroma chemistry atypical of the types of beans roasted by only conventional thermal roasting. The balance of aroma compounds associated with toasted cereal notes such as dimethyl disulfide to aroma compounds associated with earthy notes such as alkyl pyrazines that are characteristic of darkly roasted robusta coffees is much higher in the roast coffee.

An aspect of the invention provides a roast coffee having a weight ratio of dimethyl disulfide to 2,3-diethyl-5-methylpyrazine of greater than 4, for example greater than 4.5, 5, 6, 7, 8, 9, 10 or 15. In an embodiment, the roast coffee of the invention has a weight ratio of dimethyl disulfide to 2,3-diethyl-5-methylpyrazine between 4.5 and 40. 2,3-diethyl-5-methylpyrazine is an aroma molecule which provides earthy notes.

Roast coffee is the material obtained by roasting coffee beans, it may for example be roasted coffee beans or roasted ground coffee beans.

The weight of aroma compounds in the roast coffee used to calculate weight ratios may be quantified after suspension of the roast and ground coffee in water using isotopically labelled standards in conjunction with solid phase microextraction and gas chromatography-mass spectrometry analysis. This Isotope Dilution Analysis (also called Stable Isotope Dilution Analysis) is a methodology for volatile analysis which provides an accurate measurement of the contents of the compounds in the roasted coffee. By spiking the labeled standards at the earliest possible phase of sample preparation, for example directly in the roast and ground coffee suspension, all physico-chemical phenomena occurring between standard addition and instrumental acquisition are fully compensated.

For example the quantification may be performed by placing 5 g of roast and ground coffee in a screw cap flask, suspending with 100 ml of boiling water and, after closing, stirring for 10 min before cooling on ice and spiking the obtained slurry with defined quantities of labeled isotopes of the analytes before an aliquot of sample is transferred into silanised glass vials that are sealed and equilibrated for 60 minutes at room temperature before aroma compounds are extracted from the headspace by solid phase microextraction at 40 °C during 10 minutes and quantified by gas chromatography-mass spectrometry.

In an embodiment, the roast coffee of the invention has a weight ratio of guaiacol to dimethyl disulfide is less than 30, for example less than 20, 15, 12, 11, 10 or 9. In an embodiment, the roast coffee of the invention has a weight ratio of guaiacol to dimethyl disulfide between 2 and 20, for example between 2.5 and 10, for further example between 3 and 9. Guaiacol is an aroma molecule associated with phenolic, medicinal, smoky notes, these notes being commonly associated with the character of robusta coffee and considered generally undesirable.

In an embodiment, the roast coffee of the invention has a weight ratio of dimethyl trisulfide to 2,3-diethyl-5-methylpyrazine greater than 0.6, for example greater than 0.65, 0.7 or 0.75. In an embodiment, the roast coffee of the invention has a weight ratio of dimethyl trisulfide to 2,3-diethyl-5-methylpyrazine between 0.6 and 5, for example between 0.7 and 4, for further example between 0.75 and 3. An increased ratio of dimethyl trisulfide to 2,3-diethyl-5-methylpyrazine is associated with reduced earthy notes.

In an embodiment, the roast coffee of the invention has a weight ratio of dimethyl disulfide to methanethiol of greater than 1.5, for example greater than 1.6, 1.7, 1.8, 1.9, 2.0, 2.1, 2.2, 2.3, 2.4, 2.5, 3.0, 3.5, 4.0 or 4.5. The roast coffee of the invention may have a weight ratio of dimethyl disulfide to methanethiol between 1.5 and 15.0, for example between 2.0 and 6.0, for further example between 2.5 and 5.0. A higher ratio of dimethyl disulfide to methanethiol is associated with more “coffeeness” from a sensorial point of view. The process of the invention is particularly effective at increasing the “coffeeness” when the extracted green coffee is roasted in the presence of superheated steam at a pressure of greater than 9.5 in step a and then combined with aqueous green coffee extract before being roasted in step b. It is particularly surprising and advantageous that the process of the invention is able to increase the “coffeeness” of robusta coffees. The roast coffee of the invention may be a robusta coffee and have a weight ratio of dimethyl disulfide to methanethiol of greater than 1.5, for example greater than 1.6, 1.7, 1.8, 1.9, 2.0, 2.1, 2.2, 2.3, 2.4, 2.5, 3.0, 3.5, 4.0 or 4.5. The roast coffee of the invention may be a robusta coffee and have a weight ratio of dimethyl disulfide to methanethiol between 1.5 and 15.0, for example between 2.0 and 6.0, for further example between 2.5 and 5.0.

In an embodiment, the roast coffee of the invention has a weight ratio of furfural to guaiacol greater than 3, for example greater than 4, 5, 6 or 7. In an embodiment, the roast coffee of the invention has a weight ratio of furfural to guaiacol between 3 and 20. In an embodiment, the roast coffee of the invention is robusta coffee and has a weight ratio of furfural to guaiacol greater than 3, for example greater than 4 or 5. In an embodiment, the roast coffee of the invention has a weight ratio of furfural to guaiacol between 3 and 10. An increase in furfural is associated with enhanced bready, toasted, sweet notes. A decrease in guaiacol is associated with a reduction in phenolic, medicinal, smoky notes, these notes being commonly associated with the character of robusta coffee and considered generally undesirable.

In an embodiment the roast coffee of the invention has a weight ratio of dimethyl disulfide to 2,3-diethyl-5-methylpyrazine of greater than 4 and a weight ratio of guaiacol to dimethyl disulfide less than 30. In an embodiment the roast coffee of the invention has a weight ratio of dimethyl disulfide to 2,3-diethyl-5-methylpyrazine of greater than 4 and a weight ratio of dimethyl trisulfide to 2,3-diethyl-5-methylpyrazine greater than 0.6. In an embodiment the roast coffee of the invention has a weight ratio of dimethyl disulfide to 2,3-diethyl-5-methylpyrazine of greater than 4, a weight ratio of guaiacol to dimethyl disulfide less than 30 and a weight ratio of dimethyl trisulfide to 2,3-diethyl-5-methylpyrazine greater than 0.6. In an embodiment the roast coffee of the invention has a weight ratio of dimethyl disulfide to 2,3-diethyl-5-methylpyrazine of greater than 4, a weight ratio of guaiacol to dimethyl disulfide less than 30, a weight ratio of dimethyl trisulfide to 2,3-diethyl-5-methylpyrazine greater than 0.6 and a weight ratio of dimethyl disulfide to methanethiol greater than 1.5.

Roast bean colour may be expressed in CTN units. CTN roast colour may vary between 0 and 200 and is determined by measuring the intensity of Infrared (IR) light (904 nm) that is back scattered by the sample when measured with a spectrophotometer, such as Neuhaus Neotec's ColorTest II®. The spectrophotometer illuminates the surface of the ground sample with monochromatic IR light at a wavelength of 904 nm from a semi-conductor source. A photo-receiver, which has been calibrated, measures the amount of light reflected by the sample. The mean value series of measurement is calculated and displayed by electronic circuit. The colour of the coffee beans is altered by its roast level. For example, green coffee beans have typically a CTN of above 200, extremely lightly roasted coffee beans have typically a CTN of around 150, lightly roasted coffee beans have typically a CTN around 100 and medium-dark coffee beans have typically a CTN of around 70. Very dark roasted coffee beans have typically a CTN around 45. The process of the invention allows the preparation of a coffee with attractive aromas usually associated with light roasting, for example light roasted arabica. Surprisingly these aromas are maintained at relatively high degrees of roasting. In an embodiment the roast coffee has a roast colour of between 30 and 100 CTN, for example between 40 and 90 CTN.

In an embodiment, the roast coffee is contained in a container, the container being for the preparation of a beverage when inserted into a beverage preparation device. The container may for example be a beverage capsule, among other configurations.

In an embodiment, the roast coffee is packaged roasted (for example partially roasted) coffee for further roasting. The packaged roasted coffee may be packed in bulk containers, for example for inter-factory transfers. The packaged roasted coffee may be packed in semi-bulk packs to be further roasted at home or in retail outlets such as cafés.

An embodiment of the invention is packaged roasted coffee for further roasting wherein the weight ratio of dimethyl disulfide to 2,3-diethyl-5-methylpyrazine is greater than 4 and the weight ratio of guaiacol to dimethyl disulfide is less than 30, for example less than 20, 15, 12, 11, 10 or 9.

In an embodiment, the packaged roasted coffee for further roasting (for example partially roasted coffee) has a roast colour of between 75 and 160 CTN, for example between 100 and 150 CTN.

An aspect of the invention is a container for use in a beverage preparation device, the container containing the roast coffee of the invention.

Those skilled in the art will understand that they can freely combine all features of the present invention disclosed herein. In particular, features described for the process of the present invention may be combined with the product of the present invention and vice versa. Further, features described for different embodiments of the present invention may be combined. Where known equivalents exist to specific features, such equivalents are incorporated as if specifically referred to in this specification.

Further advantages and features of the present invention are apparent from the non-limiting examples.

### EXAMPLES

### Example 1: Green Coffee Extraction

Green coffee beans were pre-wetted to a moisture content of 50-60% and then extracted with water at 80-90 °C for 60 min with a weight ratio of water to beans of 3.5:1 to provide extracted coffee beans and a green coffee extract. The extracted coffee beans were dried to a moisture content of 12 wt. %. The extracted coffee beans had a sucrose content of approximately 10% of the level of sucrose in the beans before extraction. The aqueous green coffee extracts from each coffee type were concentrated by evaporation to 25% total solids.

### Example 2: Two-Step Roasting, Pressure with Steam, No Addition of Extract

Roasting under pressure with steam: 500 grams of extracted coffee beans were weighed and manually fed to a perforated rotatable drum in a pressurizable chamber. The pressurizable chamber is isolated from the environment by means of ball valves. The coffee was set in motion by rotating the drum. Superheated steam at 13 bar and 300 °C was metered into the pressurizable chamber. Pressures were chosen to give a dark to medium-dark roast colour after both roasting steps without burning the beans. After 300 s, the flow of steam to the pressurizable chamber was stopped and the pressure reduced quickly to atmospheric pressure. The rotating drum reversed direction and the coffee was metered to the exit of the pressurizable chamber. The processed coffee was then collected through a valve assembly at the bottom of the pressurizable chamber.

Roasting at atmospheric pressure without steam: 350 grams of the coffee roasted with steam as above was loaded into a perforated drawer that can be subjected to a stream of hot air at a desired temperature. The temperature of the coffee beans is measured by means of a temperature probe. After 300 s at 210 °C the roasted coffee was transferred to a cooling chamber and contacted with a stream of ambient temperature air, stopping the roasting process. The samples were then collected from the cooling chamber. The arabica sample is referred to as SA, the robusta sample as SB

### Example 3: Two-Step Roasting, Pressure with Steam, Addition of Extract

Roasting under pressure with steam: 500 grams of extracted coffee beans were weighed and manually fed to a perforated rotatable drum in a pressurizable chamber. The pressurizable chamber is isolated from the environment by means of ball valves. The coffee was set in motion by rotating the drum. Superheated steam at 13 bar and 300 °C was metered into the pressurizable chamber. Pressures were chosen to give a dark to medium-dark roast colour after both roasting steps without burning the beans. After 300 s, the flow of steam to the pressurizable chamber was stopped and the pressure reduced quickly to atmospheric pressure. The rotating drum reversed direction and the coffee was metered to the exit of the pressurizable chamber. The processed coffee was then collected through a valve assembly at the bottom of the pressurizable chamber.

Incorporation of extract into roasted extracted beans: 2.85 kg of the extracted beans roasted under pressure with steam as above were combined with 2.2 kg of coffee extract from example 1 (arabica extract was combined with roasted extracted arabica beans and robusta extract was combined with roasted extracted robusta beans). The extracts had total solids contents of 25%. The beans and extract were gently mixed in a double-jacketed Stephan mixer at 50 °C with a rotating arm for 24 hours. The beans absorbed all the extract. After mixing, the beans were rinsed with fresh water and dried to a moisture content of 12%.

Roasting at atmospheric pressure without steam: 350 grams of the roasted extracted beans where extract had been incorporated (as above) were loaded into a perforated drawer that can be subjected to a stream of hot air at a desired temperature. The temperature of the coffee beans is measured by means of a temperature probe. After 300 s at 210 °C the roasted coffee was transferred to a cooling chamber and contacted with a stream of ambient temperature air, stopping the roasting process. The samples were then collected from the cooling chamber. The arabica sample is referred to as SEA, the robusta sample as SEB.

### Example 4: Two-Step Roasting, Pressure with Nitrogen, Addition of Extract

Roasting under pressure with nitrogen: 500 grams of extracted coffee beans were weighed and manually fed to a perforated rotatable drum in a pressurizable chamber. The pressurizable chamber is isolated from the environment by means of ball valves. The coffee was set in motion by rotating the drum. Nitrogen at 18 bar and 300 °C was metered into the pressurizable chamber. Pressures were chosen to give a dark to medium-dark roast colour after both roasting steps without burning the beans. After 300 s, the flow of nitrogen to the pressurizable chamber was stopped and the pressure reduced quickly to atmospheric pressure. The rotating drum reversed direction and the coffee was metered to the exit of the pressurizable chamber. The processed coffee was then collected through a valve assembly at the bottom of the pressurizable chamber.

Incorporation of extract into roasted extracted beans: 2.85 kg of the extracted beans roasted under pressure with nitrogen as above were combined with 2.2 kg of coffee extract from example 1 (arabica extract was combined with roasted extracted arabica beans and robusta extract was combined with roasted extracted robusta beans). The extracts had total solids contents of 25%. The beans and extract were gently mixed in a double-jacketed Stephan mixer at 50 °C with a rotating arm for 24 hours. The beans absorbed all the extract. After mixing, the beans were rinsed with fresh water and dried to a moisture content of 12%.

Roasting at atmospheric pressure: 350 grams of the roasted extracted beans where extract had been incorporated (as above) were loaded into a perforated drawer that can be subjected to a stream of hot air at a desired temperature. The temperature of the coffee beans is measured by means of a temperature probe. After 300 s at 210 °C the roasted coffee was transferred to a cooling chamber and contacted with a stream of ambient temperature air, stopping the roasting process. The samples were then collected from the cooling chamber. The arabica sample is referred to as NEA, the robusta sample as NEB.

### Example 5: Comparative Samples

Roasting under pressure with steam: 500 grams of unextracted coffee beans were weighed and manually fed to a perforated rotatable drum in a pressurizable chamber. The pressurizable chamber is isolated from the environment by means of ball valves. The coffee was set in motion by rotating the drum. Superheated steam at 16 bar and 300 °C was metered into the pressurizable chamber. Pressures were chosen to give a dark to medium-dark roast colour after both roasting steps without burning the beans. After 300 s, the flow of steam to the pressurizable chamber was stopped and the pressure reduced quickly to atmospheric pressure. The rotating drum reversed direction and the coffee was metered to the exit of the pressurizable chamber. The processed coffee was then collected through a valve assembly at the bottom of the pressurizable chamber.

350 grams of the coffee roasted with steam as above was loaded into a perforated drawer that can be subjected to a stream of hot air at a desired temperature. The temperature of the coffee beans is measured by means of a temperature probe. After 300 s at 210 °C the roasted coffee was transferred to a cooling chamber and contacted with a stream of ambient temperature air, stopping the roasting process. The samples were then collected from the cooling chamber. The resulting coffees are referred to as SRefA (arabica) and SRefB (robusta).

Roasting under pressure with nitrogen: 500 grams of unextracted coffee beans were weighed and manually fed to a perforated rotatable drum in a pressurizable chamber. The pressurizable chamber is isolated from the environment by means of ball valves. The coffee was set in motion by rotating the drum. Nitrogen at 16 bar and 300 °C was metered into the pressurizable chamber. Pressures were chosen to give a dark to medium-dark roast colour after both roasting steps without burning the beans. After 300 s, the flow of nitrogen to the pressurizable chamber was stopped and the pressure reduced quickly to atmospheric pressure. The rotating drum reversed direction and the coffee was metered to the exit of the pressurizable chamber. The processed coffee was then collected through a valve assembly at the bottom of the pressurizable chamber.

350 grams of the beans roasted under pressure with nitrogen were loaded into a perforated drawer that can be subjected to a stream of hot air at a desired temperature. The temperature of the coffee beans is measured by means of a temperature probe. After 300 s at 210 °C the roasted coffee was transferred to a cooling chamber and contacted with a stream of ambient temperature air, stopping the roasting process. The samples were then collected from the cooling chamber. The resulting coffees are referred to as NRefA (arabica) and NRefB (robusta).

Roasting in a single step at atmospheric pressure: Further reference samples were prepared as follows. 350 grams of unextracted coffee was loaded into a perforated drawer that can be subjected to a stream of hot air at a desired temperature. The temperature of the coffee beans is measured by means of a temperature probe. The roasting times for the arabica and robusta samples were adjusted to obtain similar roast colours; 360 s at 220 °C for arabica and 600 s at 220 °C for robusta. The roasted coffee was transferred to a cooling chamber and contacted with a stream of ambient temperature air, stopping the roasting process. The samples were then collected from the cooling chamber. The arabica sample is referred to as CRefA, the robusta sample as CRefB.

### Example 6: Technical Tasting

The roasted coffees were prepared for tasting with a filter coffee machine. 50 g of coffee was extracted with 1000 ml water at a temperature of 100 °C. Technical tasting was performed by 6 people. Each person noted their comments on the taste and aroma of each sample. The samples according to the invention (SA, SB, SEA, SEB, NEA and NEB) all had comments concerning cereal notes whereas there were no comments regarding cereal notes for the comparative examples. Rubbery earthy notes were less frequently remarked upon for the robusta samples roasted according to the invention than for the comparative robusta samples. SEB in particular was described as having medium roast character, and showed a balanced “coffeeness” profile, which is unusual for a robusta coffee.

### Example 7: Aroma Analysis

Absolute contents (mg/kg of roasted coffee) of the aroma compounds of interest were quantified in the roast and ground coffee (R&G) after suspension in water using isotopically labelled standards in conjunction with solid phase microextraction and gas chromatography-mass spectrometry (SPME-GC-MS/MS) analysis. This Isotope Dilution Analysis (also called Stable Isotope Dilution Analysis) is a volatile analysis method which provides an accurate measurement of the contents of the compounds in the roasted coffee. By spiking the labeled standards at the earliest possible phase of sample preparation, here directly in the roast and ground coffee suspension, all physico-chemical phenomena occurring between standard addition and instrumental acquisition are fully compensated.

### Sample Preparation

5 g of roast and ground coffee sample was placed in a screw cap flask, suspended with 100 ml of boiling water and, after closing, stirred for 10 min. After cooling on ice, the obtained slurry was spiked with defined quantities of labeled isotopes of the analytes, and an aliquot of sample (7 ml) was transferred into silanised glass vials that were sealed (standard 20 ml vials used for headspace/SPME analysis).

### Extraction of Aroma

The sample was equilibrated for 60 min at room temperature. Aroma compounds were then extracted from the headspace by solid phase microextraction (SPME) at 40 °C during 10 min (2 cm fiber, 50/30 μm StableFlex, coated with PDMS/DVB/Carboxen; Supelco, Buchs, Switzerland), and thermally desorbed into the split-splitless injector (in split-mode; split of 2) heated at 240 °C for 10 min.GC-MS/MS analysis of compounds of interest

Separation was carried out on a 60 m×0.25 mm×0.25 μm polar DB-624UI column (Agilent, Basel, Switzerland) using an Agilent 7890B gas chromatograph (Agilent, Basel, Switzerland). Helium was used as carrier gas with a constant flow of 1.2 mL/min. Following oven program was applied: initial temperature of 40 °C was held for 6 min, then raised to 240 °C at 6 °C/min, and final temperature held for 10 min. Mass spectrometry was performed on an Agilent 7010 Triple Quad mass spectrometer (Agilent, Basel, Switzerland). Chromatograms were processed using the Agilent MassHunter software.

Aroma results
Absolute contents (mg/kg of roasted coffee) and ratios of the aroma compounds of interest

| | Sample Name | | | | | |
|---|---|---|---|---|---|---|
| | SA | SB | SEA | SEB | NEA | NEB |
| dimethyl disulfide | 0.343 | 0.524 | 0.513 | 1.657 | 0.348 | 1.394 |
| dimethyl trisulfide | 0.019 | 0.027 | 0.035 | 0.120 | 0.025 | 0.086 |
| methanethiol | 0.304 | 0.285 | 0.209 | 0.344 | 0.205 | 0.337 |
| 2,3-diethyl-5-methylpyrazine | 0.070 | 0.070 | 0.031 | 0.047 | 0.032 | 0.071 |
| guaiacol | 2.024 | 2.681 | 3.202 | 5.494 | 2.949 | 4.742 |
| furfural | 24.381 | 37.973 | 46.885 | 30.331 | 43.859 | 20.057 |
| Ratios | | | | | | |
| dimethyl disulfide/2,3-diethyl-5- | 4.88 | 7.50 | 16.30 | 35.50 | 11.00 | 19.52 |
| methylpyrazine | | | | | | |
| guaiacol/dimethyl disulfide | 5.899 | 5.121 | 6.237 | 3.316 | 8.463 | 3.401 |
| dimethyl trisulfide/2,3-diethyl-5- | 0.27 | 0.38 | 1.12 | 2.57 | 0.79 | 1.20 |
| methylpyrazine | | | | | | |
| dimethyl disulfide/methanethiol | 1.13 | 1.83 | 2.45 | 4.81 | 1.70 | 4.14 |
| furfural/guaiacol | 12.048 | 14.163 | 14.644 | 5.521 | 14.874 | 4.230 |
| | Sample Name | | | | | |
| | SRefA | SRefB | NRefA | NRefB | CRefA | CRefB |
| dimethyl disulfide | 0.033 | 0.135 | 0.108 | 0.161 | 0.220 | 0.542 |
| dimethyl trisulfide | 0.004 | 0.011 | 0.011 | 0.012 | 0.026 | 0.039 |
| methanethiol | 0.035 | 0.092 | 0.098 | 0.139 | 0.188 | 0.315 |
| 2,3-diethyl-5-methylpyrazine | 0.010 | 0.045 | 0.117 | 0.165 | 0.132 | 0.220 |
| guaiacol | 3.199 | 10.273 | 4.367 | 8.694 | 9.261 | 40.837 |
| furfural | 8.079 | 26.151 | 27.154 | 22.410 | 15.323 | 5.624 |
| Ratios | | | | | | |
| dimethyl disulfide/2,3-diethyl-5- | 3.35 | 2.98 | 0.92 | 0.97 | 1.67 | 2.47 |
| methylpyrazine | | | | | | |
| guaiacol/dimethyl disulfide | 98.004 | 76.097 | 40.381 | 54.086 | 42.006 | 75.365 |
| dimethyl trisulfide/2,3-diethyl-5- | 0.42 | 0.23 | 0.09 | 0.08 | 0.20 | 0.18 |
| methylpyrazine | | | | | | |
| dimethyl disulfide/methanethiol | 0.93 | 1.47 | 1.11 | 1.15 | 1.17 | 1.72 |
| furfural/guaiacol | 2.525 | 2.546 | 6.217 | 2.578 | 1.655 | 0.138 |

The samples according to the invention (SA, SB, SEA, SEB, NEA and NEB) all have higher ratios of dimethyl disulfide to 2,3-diethyl-5-methylpyrazine than the comparative samples. Dimethyl disulfide is associated with toasty cereal notes while alkyl pyrazines such as 2,3-diethyl-5-methylpyrazine are associated with earthy notes, characteristic of darkly roasted robusta coffees. The higher levels of dimethyl disulfide therefore bring enhanced cereal notes. All the samples according to the invention have lower levels of 2,3-diethyl-5-methylpyrazine than the conventionally roasted coffees CRefA and CRefB. In particular, when the extracted green coffee is pressure roasted with nitrogen in step a and then combined with aqueous green coffee extract before being roasted in step b, (samples NEA and NEB) the roasted coffee has lower levels of 2,3-diethyl-5-methylpyrazine than the comparative examples NRefA and NRefB.

The samples according to the invention (SA, SB, SEA, SEB, NEA and NEB) all have lower ratios of guaiacol to dimethyl disulfide than the comparative examples. Guaiacol is an aroma molecule associated with phenolic, medicinal, smoky notes, these notes being commonly associated with the character of robusta coffee and considered generally undesirable. In particular it can be seen for robusta coffee that when the extracted green coffee is pressure roasted with nitrogen or superheated steam in step a and then combined with aqueous green coffee extract before being roasted in step b, (samples SEB and NEB) the roasted coffee has much lower levels of guaiacol than the comparative examples SRefB, NRefB and CRefB.

It can be seen that when extracted green coffee is pressure roasted with superheated steam in step a and then combined with aqueous green coffee extract before being roasted in step b, (samples SEA and SEB) the roasted coffee has a much higher ratio of dimethyl disulfide to methanethiol than the comparative two step roasting samples SRefA and SRefB or the conventional roasting samples CRefA and CRefB. This is particularly pronounced for the robusta sample SEB which had a ratio of dimethyl disulfide to methanethiol over three times higher than the reference SRefB. A higher ratio of dimethyl disulfide to methanethiol is associated with more “coffeeness” character.

The arabica samples according to the invention (SA, SEA and NEA) all have higher ratios of furfural to guaiacol than the comparative arabica samples (SREfA, NRefA and CRefA). The robusta samples according to the invention (SB, SEB and NEB) all have higher ratios of furfural to guaiacol than the comparative arabica samples (SRefB, NRefB and CRefB). Guaiacol is an aroma molecule associated with phenolic, medicinal, smoky notes, these notes being commonly associated with the character of robusta coffee and considered generally undesirable. An increase in furfural has positive associations with bready, toasted, sweet notes.

### Example 8: Roast Colour

Roast colour: The roast colour was determined by measuring the intensity of Infrared (IR) light (904 nm) that was back scattered by the sample when measured with a Neuhaus Neotec's ColorTest II® spectrophotometer.

| | Sample Name | | | | | |
|---|---|---|---|---|---|---|
| | SA | SB | SEA | SEB | NEA | NEB |
| Roast colour (CTN) | 75 | 73 | 63 | 64 | 85 | 80 |

| | Sample Name | | | | | |
|---|---|---|---|---|---|---|
| | SRefA | SRefB | NRefA | NRefB | CRefA | CRefB |
| Roast | 37 | 61 | 74 | 111 | 62 | 61 |
| colour (CTN) | | | | | | |

1: A process for roasting coffee, the process comprising:
a. roasting extracted green coffee at a pressure greater than 2 bar for a period between 20 and 900 seconds, wherein the extracted green coffee before roasting comprises sucrose at an amount of less than 80% of the amount of sucrose in an un-extracted sample of the same coffee; and
b. roasting the roasted extracted coffee of step a at a pressure between 0.5 bar and 1.5 bar and at a coffee temperature between 180 °C and 260 °C for a period between 20 and 1200 seconds.

2: The process of claim 1 wherein the extracted green coffee is obtained by extracting green coffee with an aqueous liquid and then separating the extracted green coffee from the extract.

3: The process of claim 2 wherein the green coffee has not been heated to temperatures above 110 °C before extraction.

4: The process of claim 1 wherein the roasted extracted coffee of step a is combined with aqueous green coffee extract before being roasted in step b.

5: The process of claim 4 wherein the aqueous green coffee extract is obtained by extracting green coffee with an aqueous liquid and then separating the extracted green coffee from the extract.

6: The process of claim 1 wherein the extracted green coffee is roasted in the presence of superheated steam at a pressure greater than 9.5 bar in step a).

7: The process of claim 1 wherein the extracted green coffee is roasted in the presence of an inert gas in step a).

8: A roast coffee having a weight ratio of dimethyl disulfide to 2,3-diethyl-5-methylpyrazine of greater than 4.

9: The roast coffee of claim 8 wherein a weight ratio of guaiacol to dimethyl disulfide is less than 30.

10: The roast coffee of claim 8 wherein a weight ratio of dimethyl trisulfide to 2,3-diethyl-5-methylpyrazine is greater than 0.6.

11: The roast coffee of claim 8 wherein a weight ratio of dimethyl disulfide to methanethiol is greater than 1.5.

12: The roast coffee of claim 8 having a roast colour of between 30 and 100 CTN.

13: The roast coffee according to claim 8 being packaged roasted coffee for further roasting.

14: The roast coffee of claim 13 wherein the coffee has a roast colour between 75 and 160 CTN.

15: A container for use in a beverage preparation device, the container containing a roast coffee having a weight ratio of dimethyl disulfide to 2,3-diethyl-5-methylpyrazine of greater than 4.
